(19) United States
(12) Patent Application Publication
(10) Pub. No.: US 2007/0175316 A1
(43) Pub. Date: Aug. 2, 2007

(54) Digital music stand

(76) Inventor: Myra Gabbasovna Kumarova, Pompano Beach, FL (US)

Correspondence Address: NIXON & VANDERHYE, PC, 901 NORTH GLEBE ROAD, 11TH FLOOR, ARLINGTON, VA, 22203, US

(21) Appl. No.: 11/587,180

(22) PCT Filed: Apr. 25, 2005
(86) PCT No.: PCT/US05/14102

§ 371 Date: Oct. 23, 2006

Related U.S. Application Data
(60) Provisional application No. 60/564,578, filed on Apr. 23, 2004.

(51) Int. Cl. G10H 7/00; A63H 5/00; G04B 13/00

(52) U.S. Cl. 84/609

(57) ABSTRACT

A digital music display stand includes an operating unit containing processing structure, memory and a display.

### BACKGROUND AND SUMMARY OF THE INVENTION

The musician's music stand is a popular device used by the novice and experienced musician. It is a simple concept that allows the musician a place for his or her music. It is adjustable in height and will rotate side to side. A downfall of the existing stand, however, is that the musician is still required to turn the pages of the music on the stand.

In an exemplary embodiment of the invention, a music display stand includes an operating unit containing processing structure, memory and a display, where the memory stores a collection of sheet music. A stand member supports the operating unit, and a foot pedal including at least one control switch communicates with the operating unit to control the display via the processing structure based on operation of the control switch. In a preferred arrangement, the foot pedal is wireless. The display stand may also include a retractable visor attached to the display and having at least one light.

### BRIEF DESCRIPTION OF THE DRAWINGS

FIG. 1 is a perspective view of the digital music stand according to the present invention;

FIG. 2 is a detailed view of the screen visor;

FIG. 3 illustrates a wireless foot pedal that controls the display; and

FIG. 4 is a close-up rear-perspective view of the wireless foot pedal.

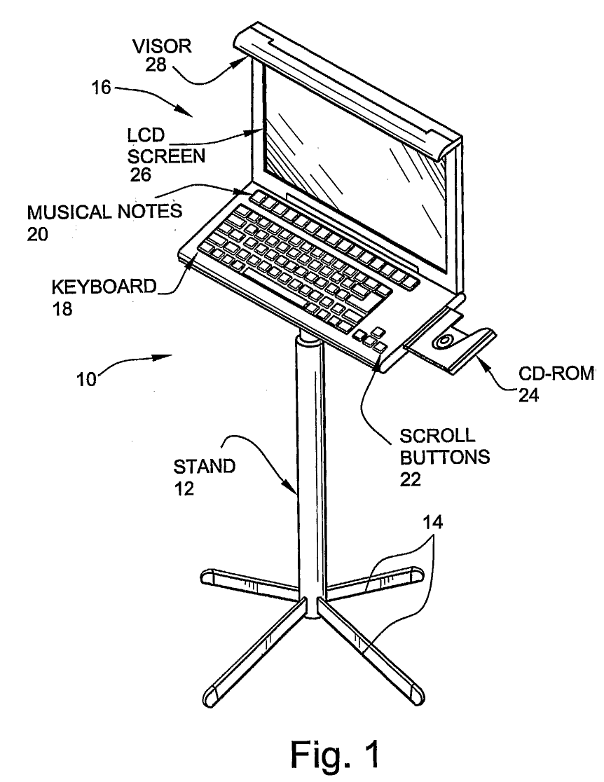

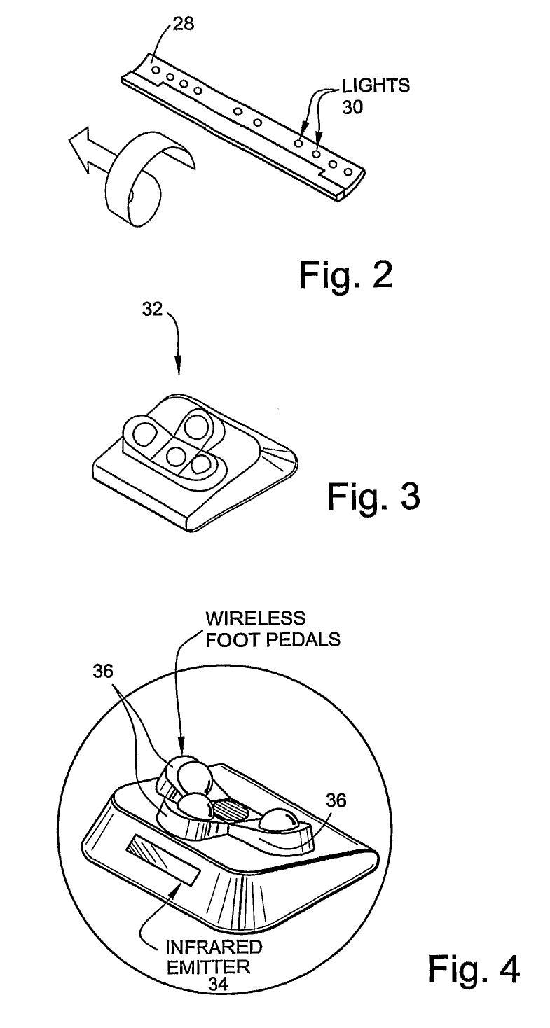

### DETAILED DESCRIPTION OF THE DRAWINGS

With reference to the drawings, the digital music stand 10 includes a suitable support or stand member 12 that can stand independently via legs 14 or the like. An operating component 16 resembles a laptop computer and includes a keyboard 18 having musical notes 20 and scroll buttons 22, a CD-ROM 24 and a display screen 26 such as an LCD display screen all controlled with suitable processing structure such as a computer processor. An optional visor 28 including lights 30 may be attached to a top portion of the display screen 26.

The processor includes known components enabling reading of digital sheet music, editing digital music, and browsing music hands-free. Exemplary known components for effecting this functionality include Music Character Recognition (MCR) and Music/Word Processing (MP) in a Rich Text-Music Format (RTMF).

A foot pedal 32 communicates with the system 16 via any suitable means such as an infrared emitter 34. The food pedal 32 is provided with multiple control switches 36 for enabling hands-free control of the displayed content.

The system utilizes suitable processing components as would be apparent to those of ordinary skill in the art. Details of the processing structure will thus not be described.

Flipper-MCR-MP is a music computer that would take the place of the musician's stand and be located in the same position. It would contain the music that is to be played and with the aid of a foot pedal would turn the pages for the musician. It allows the musician to keep both hands on the musical instrument at all times during concerts and/or performances. This allows for better concentration of the music being played and no interruptions involving the turning of pages.

The design of Flipper-MCR-MP calls for plastic, metal, and electrical components to be utilized as its major components.

Flipper-MCR-MP would be constructed of the best quality materials commonly accepted and used in the manufacturing industry today. The materials used would be selected from available materials on the market today. The production process related to the use of these materials would ensure that they were produced so as to be durable and strong. The selected materials should have high impact strength and be able to accept and retain coloring materials for an extended length of time. The materials used in the production of this invention should also be selected for its lasting traits and be versatile and of high quality.

Flipper-MCR-MP would operate as does the traditional computer of today. It would measure approximately ten inches in width by fifteen inches in length by one and one half to two inches in depth. It would be of a rectangle shape. Flipper-MCR-MP would be capable of playing and/or editing music. The keyboard would contain music note keys along with letters and a scroll. It would be capable of music processing and character recognition. A foot pedal would be attached for the purpose of flipping the pages when reading music. It would also download, edit, and/or browse music selections via the CD-ROM.

The main idea of bringing into existence of this device is to (1) get rid of messy paper sheet music books and the necessity to write by hand; (2) allow for music/word processing as well as recording/storing/downloading and printing out all music digitally; and (3) allow for hands-free music browsing. The hardware part is based on a laptop computer with the modified keyboard: half music note/half letter keys that will allow the musicians/composers to write/edit music. The software part will allow the musicians/orchestra conductors to write/make notes/edit/store music and text at the rehearsal using the keyboard in a Rich Text-Music Format (RTMF). All the music will be stored either on a hard drive or downloaded from the removable media (CD, DVD) or a remote server. The compatible format files can be also downloaded from the internet or a local area network. A CD/DVD-burner will allow for making copies. In an orchestra/band all the PCs will be connected to each other through the local area network with the conductor's PC preferably acting as a server. The members of the orchestra can share the common music database or download file modifications done by one person, usually the conductor.

The wireless pedal with infra-red sensors (WFP-ir) will eliminate the hassle of having to attach it and untangle wires. It will allow the musicians/composers/conductors/members of the band or orchestra to browse the music without having to lean over every time in order to flip the pages by hand while performing (play, rewind, forward, back, fast forward) and scroll the pages back and forth. The WFP-ir will give the musicians the freedom of adjusting the pedal on the floor according to their own height, weight, type and size of the musical instrument they are using, personal habits and anatomic characteristics. Some might punch the key by hand if at that moment their feet are busy using pedals (like piano's pedals). A regular mouse and cursor are an option as well.

Flipper-MCR-MP would eliminate the need to use and/or store paper music books. Individual musicians, students, and composers as well as orchestras and bands would utilize Flipper-MCR-MP.

All electronic components would be selected from those currently having the highest industry ratings. These components would meet and/or exceed all safety usage regulations also. Wiring and associated connecting hardware along with any receiving and/or transmission devices should be insulated and otherwise protected from intrusion by any harmful or degrading elements including water, medium level temperatures, and low to medium impact force.

Modifications for Flipper-MCR-MP would include a monitor visor. This visor would be to stop the glare from stage lights on the LCD screens. This visor would be hydraulically or mechanically retractable. Another modification is to modify the monitor visor to feature small individual lighting on the under side of the visor.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A music display stand comprising:
an operating unit containing processing structure, memory and a display, the memory storing a collection of sheet music;
a stand member supporting the operating unit;
a foot pedal including at least one control switch, the foot pedal communicating with the operating unit to control the display via the processing structure based on operation of the control switch; and
a visor attached to the display and extending across substantially a width of the display, the visor comprising at least one light.

2. A music display stand according to claim 1, wherein the foot pedal is wireless.

3. (canceled)

4. A music display stand according to claim 1, wherein the processing structure comprises means for reading and downloading digital sheet music.

5. A music display stand according to claim 1, wherein the processing structure comprises means for editing digital sheet music.

6. A music display stand according to claim 1, wherein the visor is retractable.
